(19) United States
(12) Patent Application Publication
(10) Pub. No.: US 2006/0225003 A1
(43) Pub. Date: Oct. 5, 2006

(54) Engineering design system using human interactive evaluation

(75) Inventors: Alice M. Agogino, Berkeley, CA (US); Raffi Kamalian, Potomac, MD (US); Hideyuki Takagi, Fukuoka (JP)

Correspondence Address: Trellis Intellectual Property Law Group, PC, 1900 EMBARCADERO ROAD, SUITE 109, PALO ALTO, CA, 94303, US

(73) Assignee: The Regents of the University of California, Oakland, CA (US)

(21) Appl. No.: 11/099,786

(22) Filed: Apr. 5, 2005

(51) Int. Cl. G06F 17/50

(52) U.S. Cl. 716/1

(57) ABSTRACT

A design system includes a design engine for generating designs, an evaluation process for evaluating the generated designs based on human visual inspection and/or domain knowledge, and an optimization process for pruning based at least in part on the evaluation. Generation of additional designs is performed based on optimization. Newly-generated designs are then subjected to the same iterative steps. In one embodiment a simulator is also used to evaluate the generated designs, in part, with numerically designed specification. Subjective human evaluation is used fully or at least in part of an optimization process to obtain final designs. Human visual inspection and domain knowledge is used to evaluate and rate key designs at different points in the evolution of a design.

### ACKNOWLEDGMENT OF GOVERNMENT SUPPORT

This invention was made with Government support under Grant (Contract) No. CCR-0306557 and the East Asian Summer Institutes (EASI) Program funded by the National Science Foundation. The Government has certain rights to this invention.

### BACKGROUND OF THE INVENTION

Automated design systems are used to assist human designers to create circuits, devices, structures, or other items. Basic components of an automated design system include a design engine and a simulator. The design engine is used to create candidate designs in an automated or semi-automated manner, where semi-automated operation includes interaction with a human user. The candidate designs are tested or simulated by the simulator until a design that meets design goals is achieved.

One type of design engine is a computer aided design (CAD) program. A CAD program for industrial design, for example, can be used to create a design of a structure such as a beam, mechanical system, automobile part, etc. The CAD program is typically executed by a processor in a computer system. A human designer interacts with the CAD software via user input devices such as a keyboard, mouse, trackball, digitizing tablet, touch screen, gesture or position detection, voice recognition, etc. Results are commonly displayed on a display screen but other output forms are possible such as providing a stereo display for three-dimensional effect, creating a physical model of a structure, etc. Different types of CAD systems can be used to create designs for any type of item.

Once a design has been created it can be submitted to a simulator program. The simulator program performs simulated tests on the item, such as by imposing mathematical forces on a three-dimensional model of the item. Simulation equations are used to determine the effect of the forces on the item. A determination can be made as to whether the item meets performance goals such as being able to resist applied forces without deforming or breaking.

As designs become more complex and the performance goals include multiple factors, the design of a suitable item becomes very time-consuming and unpredictable. Sometimes many designs will be created and simulated before a suitable design for an item is identified. Fully-automated systems may generate and test hundreds, thousands, tens of thousands or more, designs. In some cases, the number of possible design choices, permutations and modifications is too large and elimination of early design choices must be made according to predetermined rules. The designs that are selected after eliminating, or “pruning,” search directions according to the rules are then used to spawn additional designs for additional testing and pruning. This cycle can continue for many iterations until a suitable design or designs are achieved.

However, this approach can often lead to less than optimal designs. In some design applications the simulator cannot model and evaluate critical design issues. The performance of a design system can suffer when the item design is complicated and has several variables, when there are multiple performance goals or requirements; when the pruning rules can not be formulated deterministically or with sufficient precision, when the sheer number of possibilities requires substantial early pruning, and for other reasons. Design systems that can fall into these categories include design systems for electrical circuits, microelectromechanical (MEM) parts or systems (MEMS), semiconductor or microelectronic circuits, discrete circuits, etc.

### SUMMARY OF EMBODIMENTS OF THE INVENTION

A design system includes a design engine for generating designs, an evaluation process for manual human evaluation of candidate designs, and an optimization process for pruning based at least in part on the evaluation. Generation of additional designs is performed based on optimization. Newly-generated designs are then subjected to the same iterative steps. In one embodiment a simulator is also used to determine whether a design meets performance goals.

Subjective human evaluation is used for an optimization process solely or in part to obtain final designs. Human visual inspection and domain knowledge are used to evaluate and rate generated designs at different points in the evolution of a design. A preferred embodiment applies subjective evaluation to designs for devices and circuits as, for example, in the electronics, microelectronics and MEMS fields. One embodiment of the invention includes the use of evolutionary computation (EC) techniques in the optimization process to generate design parameters. EC optimization based on human evaluation is typically referred to as Interactive Evolutionary Computation (IEC), and hence one embodiment uses the framework of the IEC. One embodiment also includes Evolutionary Multi-objective Optimization (EMO) techniques such as a multi-objective genetic algorithm (MOGA). Other optimization approaches, such as simulated annealing and stochastic optimization, can be designed to handle multiple objectives and synthesize new configurations and can also be used.

In one embodiment the invention provides a method for designing a device, the method comprising: generating a plurality of device designs; displaying one or more of the plurality of designs on a display device; accepting a signal from a user input device to rank the displayed one or more of the plurality of designs; and using the evaluation to generate a subsequent plurality of designs.

### BRIEF DESCRIPTION OF THE DRAWINGS

FIG. 1 shows basic components in a design system;

FIG. 2 shows an alternative design system;

FIG. 3 shows an example of a MEMS design;

FIG. 4 shows the diagram of FIG. 2 including initialization operations;

FIG. 5 shows a data selection interface to select an initial population; and

FIG. 6 shows a selection display.

### DETAILED DESCRIPTION OF EMBODIMENTS OF THE INVENTION

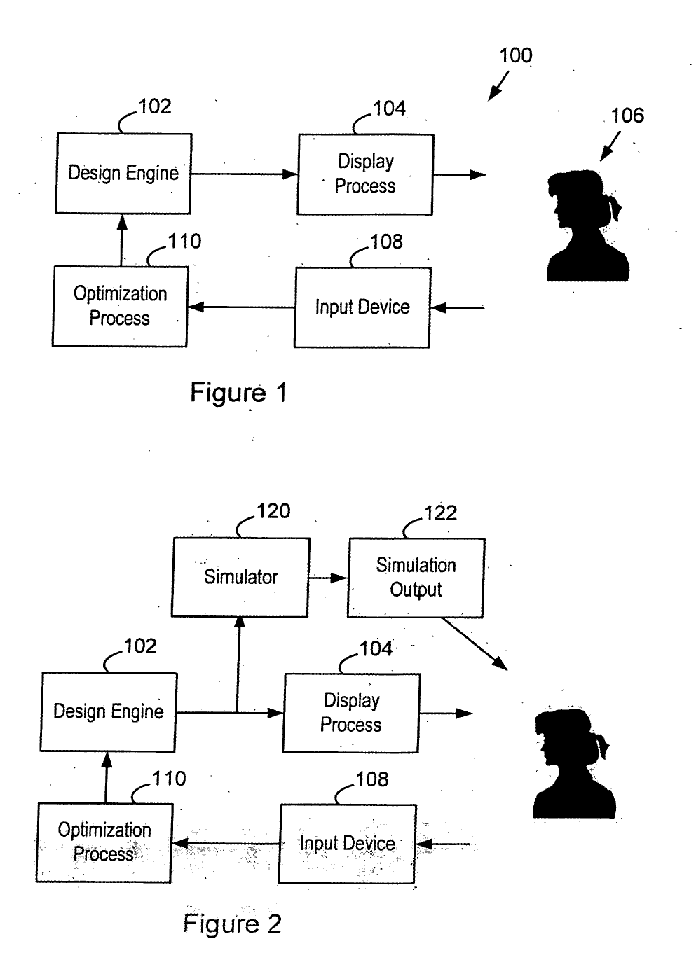

FIG. 1 shows basic components in a design system 100 according to a first embodiment. In FIG. 1, design engine 102 is used to generate initial designs for evaluation. Display process 104 is used to select, arrange and visually present the initial designs to human 106. Human 106 provides subjective evaluations of the designs via input device 108. The evaluation information is used by optimization process 110 to select design parameters for further consideration. The selected design parameters are used to generate other potential design parameters, and the generated parameters are provided to design engine 102 for generation of successive designs. The successive designs are provided to display process 104 to repeat the display, evaluation, optimization and generation steps until a suitable design is achieved.

The system of FIG. 1 allows human evaluation, such as ranking or rating, to be obtained at 108. The evaluation data is used to create new designs based on higher-evaluated designs. Lower-evaluated designs are not given as much weight and may even be discarded from consideration and further use. Note that various approaches can be used to implement each of the components of FIG. 1. For example, design engine 102 can be an automated CAD system, semi-automated system or an optimal design system. In a preferred embodiment, discussed below, an optimization process 110 includes an evolutionary computation (EC) technique. Optimization process 110 can use any type of evaluation, or criteria to determine whether a design, group of designs, design property or other design characteristics are desirable. In a preferred embodiment, human evaluation is used solely or together with automated evaluation to select preferred designs from which future variants are derived.

FIG. 2 shows an alternative embodiment that includes simulator process 120 and simulation output 122. The addition of a simulation process is used to enhance the human's ability to perform evaluation. In other embodiments, the results of a simulation can also be used as an input to optimization process 110 as well as human evaluation. In general, a combination of automated and manual operations or inputs can be used unless otherwise stated.

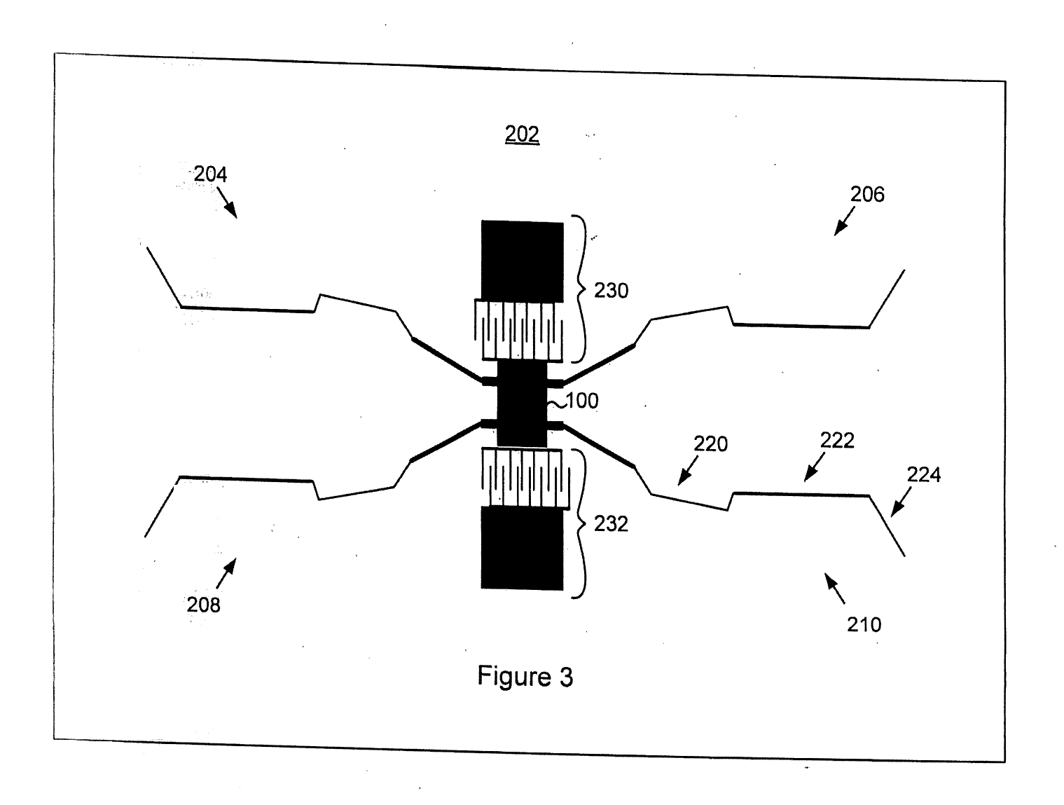

For purposes of illustration, a design example will be discussed whereby it is desired to produce a design for a MEMS resonating mass. An example of a design is shown in FIG. 3. Mass 200 is suspended above substrate 202 supported by four legs 204, 206, 208 and 210. Each leg can include multiple beam segments such as 220, 222, 224 (including others present but not referenced in FIG. 3) for leg 210. The center mass has two electrostatic “comb drives” 230 and 232 attached to it in order to facilitate actuation and capacitive position sensing during characterization. In this example, the center mass and comb drive geometry characteristics are fixed so that only the design of the four legs are variable. Each leg includes a variable number of beams and each beam has length, width, and angle as free design variables and there is a limit on the number of beams per leg. Table I shows design parameters and constraints used in this example. The beam material properties and other characteristics are predetermined and fixed. However, it should be apparent that any number and type of factors or characteristics can be variable in other applications, as desired.

TABLE I

| Parameter Name | Value | |
|---|---|---|
| Center mass | 5.3066e−011 | kg |
| Leg symmetry constraint | On | |
| Manhattan angle only constraint | Off | |
| Max number of beams per leg | 7 | |
| Min number of beams per leg | 1 | |
| Max beam length | 100 | μm |
| Min beam length | 10 | μm |
| Max beam width | 10 | μm |
| Min beam width | 2 | μm |
| Max beam angle | π/2 | |
| Min beam angle | −π/2 | |

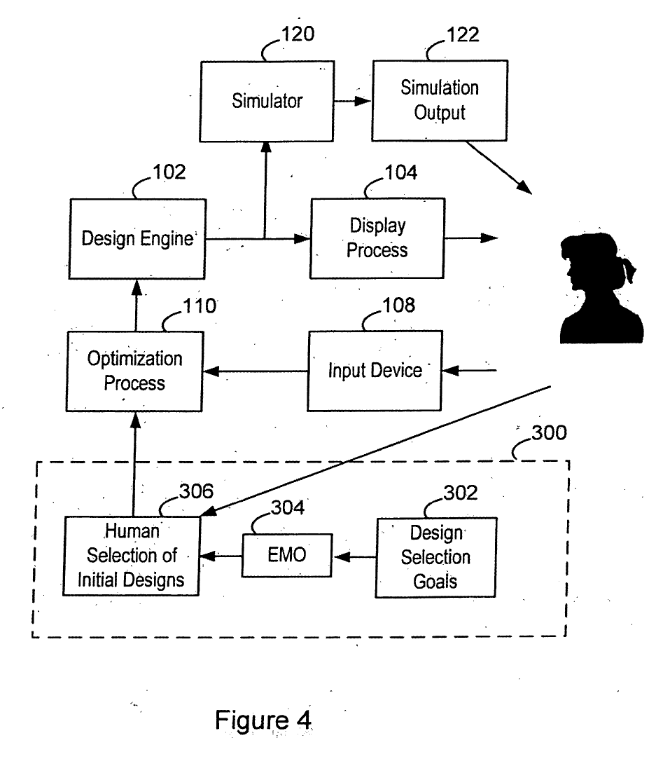

FIG. 4 shows the diagram of FIG. 2 including initialization operations 300 in a method for performing design creation for the MEMS resonating mass. Other design systems can vary from that shown in FIG. 4.

Initial design goals are specified at 302 and are submitted to EMO design engine 304. In this case, the initial design engine is an EMO type engine but other engines can be used. Four objective functions are formulated as a minimization of the distances to four goals: resonant frequency (100 kHz), suspension stiffness in the lateral direction (100 N/m), stiffness in longitudinal direction (1 N/m), and device area (device area goal=0, i.e., area is minimized). The device area is defined by the area contained within a rectangle bounding the resonator's center mass, comb drives and beams, but not the anchors and contact pads above and below each comb drive. The center mass is considered a parameter and not a design variable for this example. Basic geometrical checking is performed to prevent beams from crossing each other as such designs could not be fabricated or operated. For this example, the designs are limited to symmetric legs, only.

The results of the final evolution-generated designs from the EMO are presented to a human user for human selection of initial designs at 306. In the preferred embodiment system described by the flowchart of FIG. 4, this initialization step is necessary regardless human selection since the Design engine would not be able to efficiently handle the large number of designs generated by EMO. In cases where the initial number of generated designs is acceptable to a subsequent generation step, the manual selection at step 306 may not be necessary.

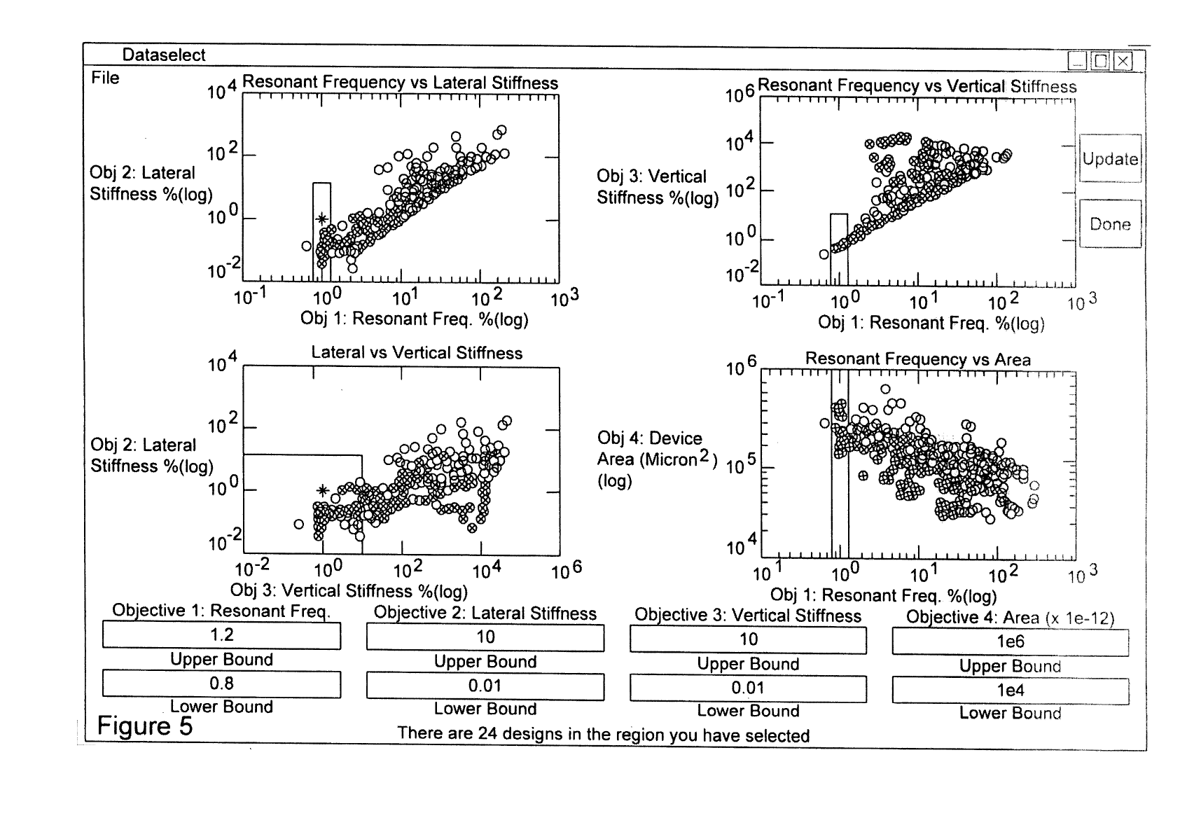

In order to perform manual selection at step 306, the human user is presented with a graph of EMO results. The user selects a region of the graph that contains a subset of the results in objective space. FIG. 5 shows a data selection interface to select an initial population. This step allows human interaction so that a user can make an expert judgment about which portion of the design space if of most value. Selecting initial candidates is made by the user defining a hyper rectangle (i.e., a multidimensional rectilinear polygon) to include a subset of the graphed points, which corresponds to a subset of generated designs. This step serves to cull the initial population for IEC from a wide array of designs spread around the objective space down to a smaller number of high evaluation designs centered around the objective goals. For example, there is little value in further evolving a design that has a resonant frequency that is an order of magnitude or more away from a desired resonant frequency goal.

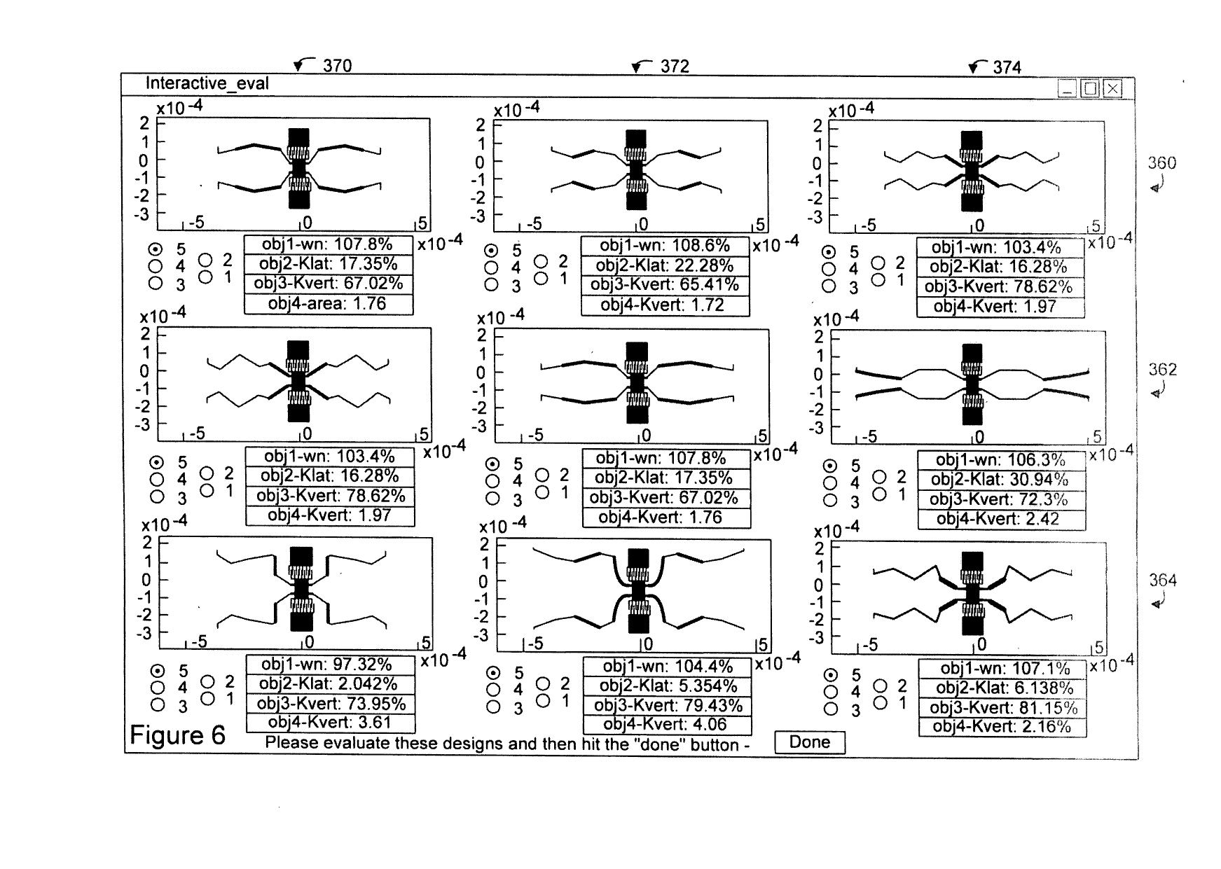

Once a region of the EMO solution space is selected, the candidates of design parameters contained within it are passed on to the Design Engine. These designs serve as a pool from which the initial population is drawn as well as new immigrants in later IEC generations. Optimization process 110 generates candidate design parameters which are then used by design engine 102 to create “parametric designs,” also simply referred to as “designs.” Parameters output by optimization process 110 can include values for physical properties (e.g., dimensions, weight, elasticity, etc.), chemical properties, color, etc. Parameters can also include math equations to define structures or other characteristics. In general, parameters can include any type of information that can be useful in generating a design. The output of design engine 102 provides generated designs, in the form of design images, for presentation to a human user via display process 104. In a preferred embodiment, the IEC interface presents the user with nine designs at a time; each design is displayed on a display screen in a three by three arrangement. An example of this display is shown in FIG. 6. Other arrangements can be used.

The IEC interface of FIG. 6 presents the user with nine designs at a time. Designs are arranged in three columns 370, 372 and 374 and in three rows 360, 362 and 364. In this example, the simulator includes a MEMS simulation tool, SUGAR, developed at the University of California at Berkeley. In other embodiments, any other type of data can be included to assist a user in performing an evaluation. Also, visual data can be presented on any type of display device. Visual data can be displayed separately from associated data. In some applications additional associated data need not be included with a visual indicator.

In FIG. 6, associated simulator data is included underneath each design. The user gives a single integrated preference score to all nine designs displayed together on the screen. The user's score is based on shape and performance, using both the visual image data and the simulator data. This allows an evaluation to include characteristics that might be apparent visually to an experienced human engineer, but that might also not be detected, or provided, by the simulator data. For example, the SUGAR simulator does not simulate stress concentrations, transient responses of structures, and other features that a human engineer or designer might perceive as awkward or difficult to fabricate or use.

The user selects a preference score from “1” (worst) to “5” (best) based on their impression of the shape and performance numbers. As a larger population size gives better, more diverse results, the IEC population size can be set to more than nine. In a preferred embodiment, a population size of twenty-seven is used to provide three windows of nine designs each. At the completion of each generation's evaluation, the user preference scores are used by the IEC to evolve the next generation. This process continues until the user chooses to end the evolution process. Other embodiments can also use automation to help determine when a design has met requirements or is sufficiently close to desired goals.

Other embodiments can use other evaluation approaches. More or less designs can be displayed and less than all of the displayed designs can be assigned a score or evaluation. Evaluations need not be simple numbers but can use e.g., sliders, knobs, or other controls or indications. A user might use voice, gestures, movement of a position indicator, degree of pressure on a button, or any other type of input to indicate an evaluation.

Designs can be arranged on the display so that the arrangement might assist a human user to understand design variations. For example, each column might correspond to a leg pattern while each row uses a different leg-to-leg spacing. Other correlations are possible. Color, animation, stereo or three-dimensional or other enhancements can be used to improve the ability of a human user to detect differences.

After each group of 27 designs is evaluated and designs are selected via input device 108, the evolutionary computation in Optimization Process 110 derives new design parameters using evolutionary operations such as selection, mutation, crossover, etc, and then Design Engine 102 generates designs that corresponding to the generated design parameters. The new design parameters are based on prior designs but weighting of use of the designs is based on the human evaluation. This iteration continues till the design that satisfies the given design specification goals is obtained.

Human users have the capability to evaluate device and circuit designs visually based on their experience and domain knowledge which are quite difficult to be described using mathematical expression or rule-based systems. By accepting user input in the design cycle, design systems can embed the human capability for designing better devices and circuits. Table II shows the performance of one embodiment (IEC+EMO) compared against a conventional non-interactive design program (EMO) in a user test. Nine of eleven users tested produced more ‘best’ designs using the invention. Using the Wilcoxon Matched-Pairs Signed-Ranks test, the invention shows better performance with

TABLE II

| | IEC + EMO | EMO | |
|---|---|---|---|
| User # | # of 5's | # of 5's | sign |
| 1 | 7 | 9 | −1 |
| 2 | 12 | 6 | 1 |
| 3 | 7 | 3 | 1 |
| 4 | 6 | 2 | 1 |
| 5 | 4 | 4 | 0 |
| 6 | 11 | 9 | 1 |
| 7 | 8 | 7 | 1 |
| 8 | 1 | 0 | 1 |
| 9 | 6 | 3 | 1 |
| 10 | 12 | 7 | 1 |
| 11 | 9 | 2 | 1 |

Once a design has been selected it can be fabricated by any suitable means. One such embodiment for MEMS design is the Multi-User MEMS Processes (MUMPS) automated fabrication process.

Although the invention has been described with respect to specific embodiments are merely illustrative, and not restrictive of the invention. For example, although a MEMS resonator design has been used as the target of design system, any other device or circuit designs might benefit from aspects of the present invention. Although specific steps for generation, optimization, and evaluation are presented, other embodiments can use different steps in place of, or in addition to, these steps. Variations in any of the specific numbers and steps presented herein are possible.

Another approach can use human evaluation to negatively weight and eliminate (rather than positively weight as described above) designs so that the human user's input is more actively used to prevent IEC resources from pursuing unpromising paths.

Another suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software or a combination of both. Unless otherwise stated, functions may also be performed manually, in whole or in part.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for designing a device, the method comprising:
generating a plurality of designs;
displaying one or more of the plurality of designs on a display device;
accepting a signal from a user input device to define evaluation information from evaluation of the displayed one or more of the plurality of designs; and
using the evaluation information to generate a plurality of design parameters for generating a subsequent plurality of designs.

2. The method of claim 1, wherein a design parameter includes a description of a structure.

3. The method of claim 1, wherein a design parameter includes a math equation.

4. The method of claim 1, wherein the step of using includes a substep of
using an evolutionary computation technique.

5. The method of claim 1, wherein the step of generating is performed by a computer-aided design engine.

6. The method of claim 1, wherein a design includes a design for a circuit.

7. The method of claim 1, wherein a design includes a design for a microelectromechanical structure.

8. The method of claim 1, wherein a device includes a circuit board.

9. The method of claim 1, further comprising:
displaying a set of the plurality of device designs on a display screen, wherein the evaluation is for the set.

10. The method of claim 9, wherein at least a portion of the plurality of device designs is displayed sequentially.

11. The method of claim 9, wherein at least a portion of the plurality of device designs is displayed simultaneously.

12. The method of claim 11, further comprising:
adjacently displaying a design and a result associated with the design on the display device.

13. The method of claim 12 further comprising:
accepting a signal from the user input device to define evaluation information for both the design and associated result.

14. The method of claim 1, further comprising:
evaluating one or more generated designs by using one or more evaluation systems, wherein the evaluation system(s) consists of one or more evaluation functions and/or one or more rule-based systems.

15. The method of claim 1, further comprising:
simulating a design to obtain a performance result; and
displaying the result.

16. The method of claim 1, wherein at least a portion of the designs are displayed sequentially.

17. The method of claim 1, wherein at least a portion of the designs are displayed simultaneously.

18. An apparatus for designing a device, the apparatus comprising:
means for generating a plurality of designs;
means for displaying one or more of the plurality of designs on a display device;
means for accepting a signal from a user input device to define evaluation information from evaluation of the displayed one or more of the plurality of designs; and
means for using the evaluation information to generate a plurality of design parameters for generating a subsequent plurality of designs.

19. A device fabricated by performing the following steps:
generating a plurality of designs;
displaying one or more of the plurality of designs on a display device;
accepting a signal from a user input device to define evaluation information from evaluation of the displayed one or more of the plurality of designs;
using the evaluation information to generate a plurality of design parameters for generating a subsequent plurality of designs;
selecting a design; and
using the selected design to fabricate a device.

20. An apparatus for designing a device, the apparatus comprising:
a processor;
a machine readable medium including instructions executable by the processor for
generating a plurality of designs;
displaying one or more of the plurality of designs on a display device;
accepting a signal from a user input device to define evaluation information from evaluation of the displayed one or more of the plurality of designs; and
using the evaluation information to generate a plurality of design parameters for generating a subsequent plurality of designs.

21. A machine readable medium including instructions executable by a processor for designing a device, the machine-readable medium comprising:
one or more instructions for generating a plurality of designs;
one or more instructions for displaying one or more of the plurality of designs on a display device;
one or more instructions for accepting a signal from a user input device to define evaluation information from evaluation of the displayed one or more of the plurality of designs; and
one or more instructions for using the evaluation information to generate a plurality of design parameters for generating a subsequent plurality of designs.
